(19) United States
(12) Patent Application Publication
(10) Pub. No.: US 2006/0210278 A1
(43) Pub. Date: Sep. 21, 2006

(54) Remote operation of local or distant infrared-controllable and non-infrared-controllable devices

(76) Inventors: Daniel Brian Cregg, Orange, CA (US); Paul V. Darbee, Coto de Caza, CA (US)

Correspondence Address: WELSH & KATZ, LTD, 120 S RIVERSIDE PLAZA, 22ND FLOOR, CHICAGO, IL, 60606, US

(21) Appl. No.: 11/085,349

(22) Filed: Mar. 21, 2005

(51) Int. Cl. H04B 10/00

(52) U.S. Cl. 398/107

(57) ABSTRACT

Tokenized commands originating in an infrared (IR) remote control are sent over a home automation network using low-cost radio-frequency (RF) and/or powerline (PL) communications to enables operation of distant IR-controllable devices not within view of the IR beam from the remote control, as well as operation of other devices that are not IR-controllable. Using IR or RF, the remote control sends only a few bytes of tokenized information designating the specific function to be controlled. An IR or RF receiver optionally retransmits the tokens over another network, such as the powerline. “IR Blaster” devices receive the tokens via RF or another network, and apply them to an IR engine that generates an IR pulse stream identical to that of the original remote control. Non-IR devices receive the tokens via RF or another network and interpret them as specific control commands.

### BACKGROUND OF THE INVENTION

1. Field of the Invention

This invention relates to infrared remote controls, infrared remote control extenders, and home automation networks using radio frequency and/or powerline communications.

2. Description of the Related Art

Infrared (IR) remote controls are ubiquitous for control of audio/video (AV) home entertainment equipment. TV displays, DVD players, VCRs, DVRs, cable boxes, satellite receivers, CD players, stereo equipment and many other devices come with an IR handset as standard equipment. Universal remote controls enable control of multiple devices with a single handset. Learning universal remotes can record IR pulse trains from another remote, compress the pulse trains for efficient storage, then uncompress and play back the pulse trains on demand. Preprogrammed universal remotes contain a compressed database of remote control functions for a large number of devices. Users set up a preprogrammed universal remote via a user interface that associates each category of device with a specific subset of commands from the database. For example, the remote could be set up so that after a “TV” button on the remote is pressed, the remote will send IR Commands appropriate for a certain model of RCA television. Then, after a “VCR” button is pressed, the remote might send IR Commands associated with a Sony VCR.

Maximum compression of the IR code database in a preprogrammed universal remote has high value, because more codes can be stored in a given size memory chip. Indeed, the IR pulse train from a single keypress typically transfers just two bytes—a one-byte manufacturer ID common to a group of commands for a device, and a one-byte command proper. Therefore, a database containing one byte per IR function plus some header information for groups of functions is common in preprogrammed universal remote controls. Such a database is said to be tokenized, and the compressed bytes for an IR Command are called tokens.

Preprogrammed universal remotes also contain a set of software routines, called executors or formatters, that receive tokens associated with a keypress and expand them into an IR pulse train appropriate for the device being controlled. Header information in the database typically points to the formatter to be used to expand a given token.

Learning universal remotes that also contain a preprogrammed database can learn codes by recognition. Software in the remote compares the format of a code being learned to that of formatters in the database. If the format is recognized, the data in the function being learned can be tokenized and stored in the same way as other functions for that format.

For an IR remote to control a device, there must be an optical path for the light to travel from the remote to the device. An unobstructed, line of sight path is best, but some remotes emit enough IR power that reflections from walls, floors or ceilings may be acceptable. However, if the controlled device is inside a cabinet, or in another room, the remote will not be able to control it. In that case, some form of IR Extender must be used. Two kinds of IR Extender are in common usage—wired and wireless.

Wired IR Extenders use a broadband IR detector to receive the raw IR pulse train and convert it to an electrical signal. The signal travels down a wire to one or more IR emitters at a distant location. One embodiment of wired IR Extender requires dedicated wires for the emitters, and another embodiment multiplexes the electrical signal onto coax cable used for video interconnection. The IR detector and the emitters both require a power supply.

Wireless IR Extenders use radio frequency (RF) to transport the IR pulse train to a distant location. An IR-to-RF device uses a broadband IR detector to receive the raw IR pulse train, then the pulse train directly modulates an RF carrier by on-off keying. One or more RF-to-IR devices receive the RF signal, demodulate it, and apply the received pulse train to an IR emitter, thus replicating the original IR signal.

Both of the above wired and wireless IR Extender systems transport the raw IR pulse train without compressing or processing it in any way. Uncompressed IR data streams are acceptable when transmitted over a dedicated wire or RF channel, but when it is desired to transmit IR Commands over a network, then the IR data stream must be encoded as a string of bytes in some way. Especially when the network is low-speed, as with RF or powerline (PL) networks designed for home automation, an uncompressed data stream can easily require more bandwidth than the network can sustain, so the IR data stream must be compressed.

Most IR communication protocols use bursts of IR pulses at a particular frequency, known as the carrier frequency. IR carrier frequencies typically range from 20 to 60 KHz, with a few above 400 KHz. 38 KHz is the most commonly used carrier frequency. It is possible to compress an IR pulse train by detecting its carrier frequency, then coding the burst envelope as, for example, a run-length code. Compared to run-length coding the raw pulse train, such a compression scheme can reduce the number of bytes needed to represent a pulse train by a factor proportional to the number of IR pulses in a burst, typically 10 to 30.

Such a burst-envelope run-length compression scheme requires no prior knowledge of the structure of the IR communications protocol. However, most IR protocols continue to transmit as long as a key on the remote is held down. Some protocols send a generic “keep alive” signal, while others retransmit the original command, possibly with some of the data in the command altered to indicate repetition. Simple run-length coding of the burst envelope cannot take advantage of such redundancy in the protocol. To detect repetition redundancy in real time without prior knowledge of which one of hundreds of possible IR protocols is being used is not possible using a low-cost microcontroller.

It is possible to implement an IR Extender by using a universal remote control chip known as an IR Blaster at a distant location. Typical IR Blasters, such as those from Universal Electronics Inc. of Cerritos, Calif., receive commands from a serial port and are capable of driving IR LEDs using a large number of preprogrammed formats. Some IR Blasters are also capable of learning codes from other IR remotes. By connecting a microcontroller communicating with a home automation network to the serial port of an IR Blaster, it is possible to receive short, highly compressed tokenized commands from the network to operate the IR Blaster. The X10 to IR Linc device from SmartHome Inc. of Irvine, Calif. can be programmed to receive specific commands following the X10 protocol of X10. Ltd. of Hong Kong over the powerline and to send out preprogrammed or learned IR pulse streams associated with those commands. A personal computer (PC), personal digital assistant (PDA), or other digital device connected to an IR Blaster via a wire or a home automation network could cause the IR Blaster to send arbitrary preprogrammed or learned IR pulse streams. However, an unmodified IR remote control cannot cause the IR Blaster to send arbitrary IR pulse streams, because such unmodified remote controls emit the same IR pulse streams that the IR Blaster can emit, and not the tokenized commands required to operate the blaster.

Home automation networks can control numerous devices that normally cannot be controlled using IR remotes. Lights, appliances, thermostats, security systems, sprinklers, and sensors are examples of devices that can be networked using RF and/or powerline communications. The protocol sold under the trademark INSTEON by SmartHome, Inc. of Irvine, Calif. uses RF, powerline, or both. ZWave from ZenSys A/S of Copenhagen, Denmark or ZigBee from the ZigBee Alliance of San Ramon, Calif. are examples of RF-only networks. Powerline-only networks include X10 from X10 Ltd. of Hong Kong and UPB (Universal Powerline Bus) from Powerline Control Systems of Northridge, Calif. These networking protocols have all been designed for low-cost, and in the case of portable devices, long battery life. Compared to networking standards for computers, such as Ethernet or WiFi (IEEE 802.11), or networking for AV distribution, such as UWB (ultra-wideband) or HomePlug from the HomePlug Powerline Alliance of San Ramon, Calif., home automation networks are low-speed.

For IR remotes to control non-IR devices on a home automation network, a bridging device must be added to the network. A bridging device receives an IR pulse train from an IR remote, decodes it, and reformats the data for transport over an RF, powerline, or other network. An example of such a device is the X10 IR Command Console, which has a plurality of push buttons that a user can press to operate lights and appliances. When the user presses a button, the Console sends an X10 signal over the powerline to X10 control modules connected to the various controlled devices. The Console also has an IR receiver capable of decoding uniquely formatted IR Commands. A dedicated or universal remote capable of sending the uniquely formatted IR Commands can thereby act as a remote keyboard for the Console. Pushing a button on the remote causes the same X10 command to be sent over the powerline as would be sent if the user pushed a corresponding button on the Console. There is no confirmation that the X10 command was in fact executed, because communication is one-way only. Although not 100 percent reliable, this bridging device enables an IR remote to control lights and appliances

### BRIEF SUMMARY OF THE PRESENT INVENTION

It is an object of the present invention to use a home automation network to implement an IR Extender by transporting maximally compressed arbitrary IR data over the network.

It is a further object of the present invention to enable an IR or RF remote control to send commands to an IR Blaster over a home automation network.

It is another object of the present invention to enable an IR or RF remote control to operate devices connected to a home automation network even if those devices are not IR or RF controllable.

According to the present invention there is provided a system for operating infrared-controllable apparatus, the system comprising

a remote control comprising circuitry for sending infrared signals;

a first apparatus comprising circuitry for receiving first infrared signals from the remote control, circuitry for decoding data from the first infrared signals, and circuitry for sending the data over a communications network; and

a second apparatus comprising circuitry for receiving the data over the communications network and circuitry for sending second infrared signals associated with the received data to the infrared-controllable apparatus.

Further according to the present invention there is provided a system for operating infrared-controllable apparatus, the system comprising

a remote control comprising circuitry for wirelessly sending commands to an infrared blaster comprising infrared-emitting circuitry able to operate infrared-controllable apparatus; and

apparatus comprising the infrared blaster, circuitry for receiving the commands for controlling the infrared blaster from the remote control, and circuitry for applying the received commands to the infrared blaster.

Also according to the present invention there is provided a system for operating non-infrared-controllable apparatus, the system comprising

a remote control comprising circuitry for wirelessly sending signals;

first apparatus comprising circuitry for receiving wireless signals from the remote control and circuitry for sending over a communications network associated commands for operating a second apparatus connected to the communications network; and

one or more of the second apparatus comprising circuitry for receiving the commands over the communications network and executing the commands.

Additionally according to the present invention there is provided a system for operating non-infrared-controllable apparatus, the system comprising a remote control comprising circuitry for wirelessly exchanging messages with non-infrared-controllable apparatus, circuitry for associating keypresses on the remote control with commands for operating the non-infrared-controllable apparatus; and

one or more of the non-infrared-controllable apparatus comprising circuitry for exchanging messages with the remote control, circuitry for executing commands received from the remote control, and circuitry for communicating with the remote control to establish in the remote control an association between keypresses on the remote control and commands for operating the non-infrared-controllable apparatus.

Still further according to the present invention there is provided a method for operating infrared-controllable apparatus, the method comprising the steps of sending a first infrared signal from an infrared-emitting remote control;

receiving the first infrared signal from the remote control, decoding data from the first infrared signal, and sending the data over a communications network; and

receiving the data over the communications network and sending a second infrared signal associated with the received data to the infrared-controllable apparatus.

Still further according to the present invention there is provided a method for operating infrared-controllable apparatus, the method comprising the steps of wirelessly sending commands from a remote control to an infrared blaster comprising infrared-emitting circuitry able to operate infrared-controllable apparatus; and

receiving the commands for controlling the infrared blaster from the remote control, and applying the received commands to the infrared blaster.

Still further according to the present invention there is provided a method for operating non-infrared-controllable apparatus, the method comprising the steps of

wirelessly sending signals from a remote control;

receiving wireless signals from the remote control by a first apparatus and sending over a communications network associated commands for operating a second apparatus connected to the communications network;

receiving the commands by the second apparatus over the communications network and executing the commands.

Still further according to the present invention there is provided a method for operating non-infrared-controllable apparatus, the method comprising the steps of

wirelessly communicating with a remote control to establish in the remote control an association between keypresses on the remote control and commands for operating the non-infrared-controllable apparatus;

exchanging messages between the remote control and the non-infrared-controllable apparatus; and

executing commands received from the remote control by the non-infrared-controllable apparatus.

### BRIEF DESCRIPTION OF THE SEVERAL VIEWS OF THE DRAWINGS

FIG. 1 is a schematic diagram of an IR control system comprising an IR remote control, an IR-to-Network Unit, a Network-to-IR Unit, and a Network Unit capable of interfacing with other devices or networks.

FIG. 2 is a schematic diagram of an IR or RF control system comprising an IR or RF remote, an RF-to-Network Unit, an RF or Network-to-IR Unit, and an RF or Network Unit capable of interfacing with other devices or networks.

FIG. 3 is a flowchart showing a method for setting up a User-Associated IR Code Extender.

FIG. 4 is a flowchart showing a method for using a User-Associated IR Code Extender.

FIG. 5 shows a first type of command for an IR Blaster, called Send_IR_For_Key.

FIG. 6 shows a second type of command for an IR Blaster, called Send_IR_Command.

FIG. 7 shows an information packet containing a Blaster Command.

FIG. 8 is a flowchart showing a method for setting up an Arbitrary IR Code Extender.

FIG. 9 is a flowchart showing a method for using an Arbitrary IR Code Extender.

FIG. 10 is a flowchart showing a method for associating an IR Command with a Network Command for controlling a Network Unit.

FIG. 11 is a flowchart showing a method for controlling a Network Unit with an associated IR Command.

FIG. 12 is a flowchart showing a method for associating a keypress on an RF remote control with a Network Command for controlling a Network Unit.

FIG. 13 is a flowchart showing a method for controlling a Network Unit with an associated keypress on an RF remote control.

### DETAILED DESCRIPTION OF THE PREFERRED EMBODIMENTS

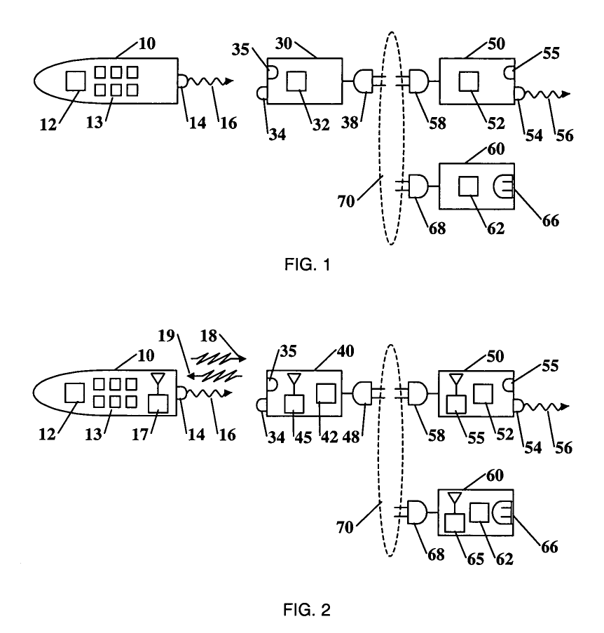

With reference now to the drawings, FIG. 1 shows an IR control system comprising an IR remote control 10, an IR-to-Network Unit 30, a Network-to-IR Unit 50, and a Network Unit 60.

The IR remote control 10 comprises a microcontroller 12, a keyboard 13, and an IR-emitting LED 14.

The IR-to-Network Unit 30 comprises a microcontroller 32, a modem 38 for coupling a communications signal to the network 70, an IR detector 35, and an optional IR emitter 34.

The Network-to-IR Unit 50 comprises a microcontroller 52, a modem 58 for coupling a communications signal to the network 70, an optional IR detector 55, and an IR emitter 54.

Notice that if the optional IR emitter 35 is included in the IR-to-Network Unit 30 and the optional IR detector 55 is included in the Network-to-IR Unit 50, then both units comprise the same component hardware, and could therefore be used interchangeably as IR-Network transceivers.

The Network Unit 60 comprises a microcontroller 62, a modem 68 for coupling a communications signal to the network 70, and circuitry 66 for interfacing with a sensor, controlled device, digital equipment, or another communications network. Such devices are in common use for home automation, often employed to switch or dim lamps, control appliances, report the status of sensors, interface with a PC, or connect to the Internet. Although not shown, such devices can have displays, touchpads, a keyboard or other user interfaces of varying complexity, utility and cost. Only one Network Unit 60 is shown in FIG. 1, but in a typical installation a plurality of such devices would normally be in use, with each device communicating with the others via the network 70.

According to the present invention, there are two methods for the system shown in FIG. 1 to implement an IR Extender. The first is called the User-Associated IR Code Extender and the second is called the Arbitrary IR Code Extender.

User-Associated IR Code Extender

The User-Associated IR Code Extender method uses an unmodified preprogrammed universal remote 10 in conjunction with an IR-to-Network Unit 30 and a Network-to-IR Unit 50. In this method, a setup procedure establishes a correspondence between keypresses on the remote control 10 and particular IR Commands to be emitted by the Network-to-IR Unit 50. After setup and during normal usage, the IR-to-Network Unit 30 picks up IR codes emitted by the remote control 10 and sends a message over the network 70 designating which key was pressed. The Network-to-IR Unit 50 receives the message and causes an internal IR Blaster to emit the particular IR Command that was associated during setup with the key that was pressed on the remote 10.

IR detector modules, shown schematically as 35, are produced in high volume for use in a myriad of IR-controllable devices. Because they are reliable and inexpensive, they are the preferred sensors for picking up IR from a remote control and outputting an electrical signal. The most common modules are tuned to detect bursts of IR pulses at a particular frequency, and the electrical signal they output is the demodulated envelope of the IR pulse train. Typical IR pulse frequencies range from 20 to 60 KHz, with 38 KHz being the most common frequency. The demodulated envelope is an electrical pulse train in a particular format.

One of the most commonly used IR control code formats, first developed by NEC Corporation, carries a payload of two bytes of data. The first byte is a manufacturer ID common to all commands for a particular IR-controllable product, and the second byte is the command proper. A simple and low-cost IR-to-Network module 30 suitable for mass production can therefore be comprised of a common 38 KHz IR detector 35 coupled to a microcontroller 32 programmed in firmware to decode the NEC protocol.

To complete the IR-to-Network module hardware, the microcontroller 32 is coupled to a network modem 38, which applies communication signals to the network in a suitable format. Network communications can be one-way or two-way, with two-way being preferred because of greatly enhanced reliability due to confirmation of valid data reception and the ability to retry if needed.

Firmware in the microcontroller 32 inserts the manufacturer ID and the command code byte of the received NEC protocol into a suitable data packet for the protocol used to communicate via the network. Additional information such as a source address, a destination address, or an “IR Keypress” command may also be formatted into the packet, depending on the communication protocol. Another firmware procedure sends the complete packet over the network to the Network-to-IR Unit 50 using the network modem hardware 38. In two-way network communications protocols, the receiving unit may send an acknowledgement when it gets an uncorrupted message, or if not, the sender may retry. There also may be intervening modules that relay or route messages, possibly over other networks or media, such as the Internet or wirelessly via RF.

The Network-to-IR Unit 50 receives the network message containing the remote control keypress data via the network modem 58. Firmware in the microcontroller 52 decodes the message to determine the manufacturer ID and command sent by the remote control.

Additional firmware in the microcontroller 52 implements an IR Blaster capable of sending IR codes from a preprogrammed library in nonvolatile memory, IR codes previously learned from another remote control via IR detector 55, or in some cases, both. During a previous setup procedure described in more detail below, the user established a correspondence between keypresses on the remote control 10 and IR codes to be emitted by the IR Blaster. When the microcontroller 52 receives a keypress that has an IR code associated with it, the microcontroller formats the IR code into an appropriate pulse train and applies the pulse train to the IR emitter 54. Note that the IR pulse train 56 emitted by the IR Blaster will not normally be the same as the IR pulse train 16 emitted by the remote control 10.

As disclosed above, the IR-to-Network Unit 30 and the Network-to-IR Unit 50 can be constructed identically as IR-Network transceivers if both units have IR emitters and detectors and both microcontrollers have the same firmware. For the IR Blaster to learn IR codes from another remote control, the IR detector should be broadband so that widely varying IR pulse rates can be detected. In fact, as disclosed by U.S. Pat. No. 6,826,370, an IR emitter can be used as such a broadband detector, if desired. There can also be a narrowband detector tuned to the protocol chosen for use by the preprogrammed universal remote control 10.

Because the NEC protocol is so common, an unmodified preprogrammed universal remote control will contain many IR codes in that format in its library of codes. In order to avoid controlling a device using the NEC protocol that is actually present in the same room as the remote control, the remote must be set up to control a device using the NEC protocol that the user does not have. Alternatively, an IR protocol expressly designed for use in a User-Associated IR Code Extender could be preprogrammed into the library of a universal remote, or else programmed into the firmware of a single-purpose, dedicated remote. Because it is desirable to use preprogrammed universal remote controls already deployed in the marketplace for this purpose, reuse of pre-existing common protocols, such as NEC, is preferred.

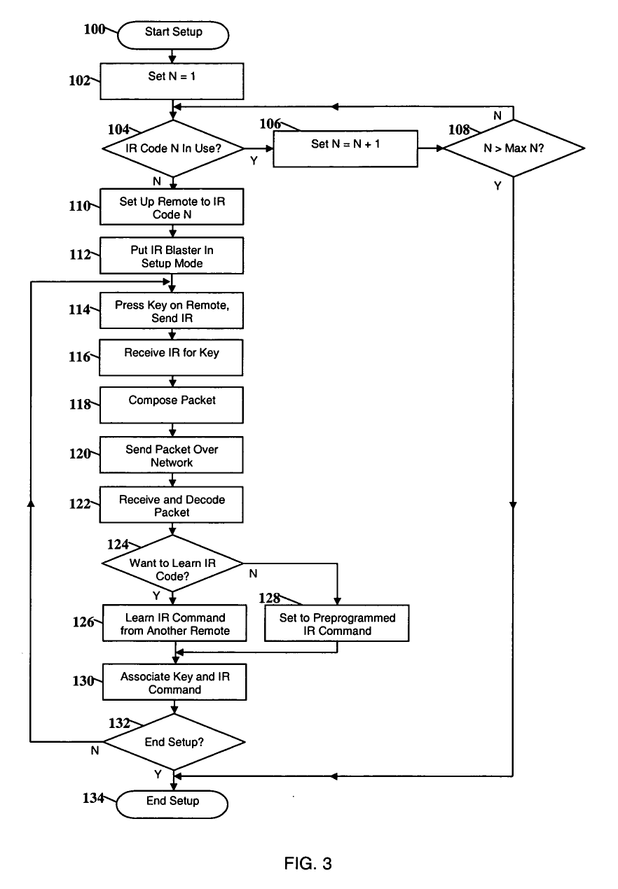

FIG. 3 is a flowchart showing a method for setting up the User-Associated IR Code Extender disclosed above. The procedure begins at step 100. At step 102 a count N is started at one. At step 104 the user looks up IR code number N, code number one in this case, in a list of IR codes that use the IR protocol chosen for sending keypresses. In a preferred embodiment the chosen IR protocol, such as the NEC protocol, appears multiple times in the library of a typical preprogrammed universal remote. If at step 104 the user finds that IR code N is already set up to operate an existing device, the next code, N+1, is selected from the list of codes at step 106. If the end of the list is found at step 108, then setup fails, but if there are more codes in the list, the user checks the next code at step 104. When an unused IR code is found at step 104, the user follows the instructions for the universal remote to set it up to send that IR code at step 110.

Next, at step 112, the user puts the Network-to-IR Unit 50 of FIG. 1 in setup mode, for instance by pressing a setup button on the unit. The user chooses a key on the remote to associate with an IR Command to be sent by the IR Blaster, and presses that key at step 114. The remote sends the IR Command for the chosen key using the protocol that was set up at step 110. The IR-to-Network Unit 30 of FIG. 1 receives the IR Command for the key at step 116, decodes the IR protocol, and extracts the command, which is typically just a one byte manufacturer's ID and a one byte command code proper. At step 118 the IR-to-Network Unit composes a packet containing the command information along with any other information the network protocol may require, then it sends the packet over the network at step 120. In a preferred embodiment the network is the powerline, but the network may also be wireless RF, wired, a LAN (Local Area Network), the Internet, or any other communications channel.

At step 122, the Network-to-IR Unit 50 of FIG. 1 receives the IR Command packet for the keypress over the network and buffers the command information. If the IR Blaster in the unit 50 is both preprogrammed and a learner, then a choice must be made at step 124. If the user wants the IR Blaster to learn an associated IR code from an existing remote, it is sufficient to press the desired button on the existing remote while pointing it at the IR detector 55 on the unit 50 in step 126. If instead the user wants to set up the IR Blaster to send an IR code from its preprogrammed library, then a user interface is needed. The user interface can take the form of buttons and indicators or a display on the unit 50, or it can be a remote device such as a keypad, a touchpad, or a PC connected to the network. Through a suitable interaction, the user interface must determine that the user wants to set up a preprogrammed command at step 124, then at step 128 it must determine which particular command in the preprogrammed library the user wishes to associate with the keypress on the remote.

Once the IR Command to be associated with the remote keypress is determined by learning or by preprogrammed setup, the Network-to-IR Unit 50 updates an internal database with the association, preferably in nonvolatile memory, at step 130. If the user wishes to set up another keypress/command association at step 132, the procedure resumes at step 114 when another key is pressed on the remote. Otherwise, the setup session is ended at step 134, for instance by pressing a setup button again on the IR-to-Network Unit 50.

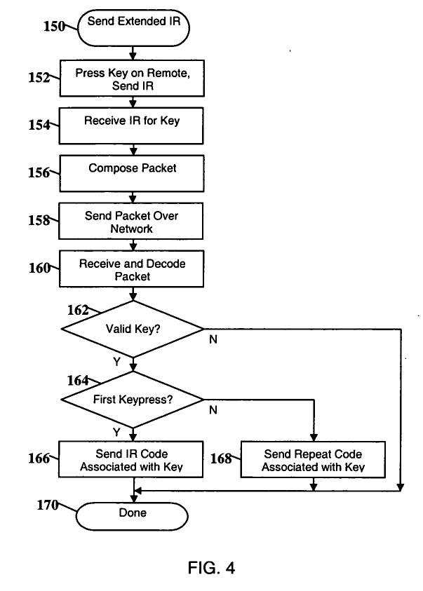

FIG. 4 is a flowchart showing a method for using the User-Associated IR Code Extender disclosed above. The procedure begins at step 150. At step 152 the user presses one of the keys on the remote previously associated with an IR Command to be emitted by the IR Blaster in the Network-to-IR Unit 50 of FIG. 1. Following steps 154, 156, 158 and 160, the command data for the IR keypress is extracted from the IR pulse train, sent over the network, and received by the Network-to-IR Unit. These steps are the same as steps 116, 118, 120 and 122 of FIG. 3, respectively.

At step 162, the Network-to-IR Unit 50 compares the IR keypress command data, typically a one-byte manufacturer's ID and a one-byte command proper, to keypress commands previously set up in its database. If the keypress command has not been previously set up, the keypress is ignored and the procedure terminates at step 170. If, however, there is an association in the database between the keypress command and an IR Command to be emitted by the IR Blaster, then at step 164 the IR Blaster checks if the key is being held down or if it is being pressed for the first time. If it is a first keypress, at step 166 the IR Blaster formats the associated IR Command (either learned or preprogrammed in a library of commands) as a pulse train and sends it using the IR emitter 54 of FIG. 1. If instead the key is being held down, the IR Blaster formats whatever modification of the IR pulse train the IR protocol requires in order to indicate command repetition, and emits the modified pulse train at step 168. The procedure terminates at step 170.

Once the database in the Network-to-IR Unit 50 of FIG. 1 contains one or more associations between received keypress command packets and IR Commands to be emitted, then any device connected to the network capable of sending properly formatted keypress command packets can cause associated IR Commands to be emitted. Keypads, touchscreens and PCs are examples of such devices. During setup, such devices can also be used instead of the remote control 10 and the IR-to-Network Unit 30 of FIG. 1 to establish associations between keypress command packets and IR Commands emitted by the IR Blaster. Note also that there can be a plurality of remote controls, IR-to-Network Units, Network-to-IR Units and other networked devices according to the present invention.

Arbitrary IR Code Extender

The Arbitrary IR Code Extender comprises the same hardware elements as the User-Associated IR Code Extender, but with different firmware running on the microcontrollers 12, 32, and 52 of FIG. 1. Whereas the User-Associated IR Code Extender requires a user to manually set up correspondences between keypresses on the remote control 10 and IR codes to be emitted by the Network-to-IR Unit 50, the Arbitrary IR Code Extender requires no such set up steps. Instead, the Network-to-IR Unit 50 is capable of automatically replicating any IR code that the universal remote control 10 can send.

To replicate an arbitrary IR pulse train at a remote location, the user switches the universal remote control 10 to Extender Mode. Then for every keypress, instead of sending the normal IR pulse train for that key, the microcontroller 12 sends a Blaster Command using a special IR protocol. The microcontroller 32 in the IR-to-Network Unit 30 receives the Blaster Command via IR detector 35, reformats it according to the network protocol, and sends it over the network using modem 38. The microcontroller 52 in the Network-to-IR Unit 50 receives the network packet via modem 58, extracts the Blaster Command, and applies it to the IR Blaster implemented in firmware. The IR Blaster executes the command by sending the same IR pulse train via IR LED 55 as would have been emitted by the remote control 10 if it were not in Extender Mode. Assuming that the IR Blaster implemented in the Network-to-IR Unit 50 contains the same IR code library as the universal remote control 10, then the IR Blaster can reproduce any IR pulse train that the remote control can send.

Blaster Commands

In the current art, the microcontroller 12 in a universal remote control 10 scans a keyboard 13 for keypresses. When a key is pressed, firmware determines what IR Command to send, formats the IR Command as a pulse train, then, in real time, drives an output pin connected to an IR emitter circuit with the pulse train. In the present invention, firmware sends a Blaster Command instead of an IR Command pulse train. A Blaster Command is a sequence of bytes which, when applied to an IR Blaster, cause the IR Blaster to emit a particular IR Command pulse train from its library, just as the microcontroller in the remote would have.

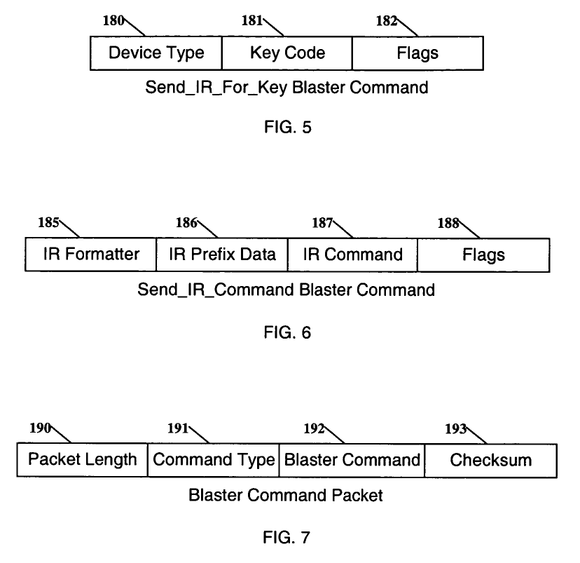

An IR Blaster can be designed to accept two types of Blaster Commands. FIG. 5 shows the first type, called Send_IR_For_Key. This Blaster Command consists of a Device Type 180, which uniquely identifies a collection of IR Commands for a set of makes and models of IR-controllable devices that use the same IR code format; a Key Code 181, indicating which IR Command in the collection to send; and an optional set of flags 182 used for special processing, such as handling repeated IR Commands. A typical IR code library is organized as a set of tables, one for each Device Type. Each table is prefixed with data indicating which IR format to use and any data that may be common to all IR Commands for the Device Type, followed by an ordered list of IR Commands. The Key Code 182 is actually a pointer into the table, based on an association between the key being pressed and an IR Command in the table. This association is known as a Pick. Note that there may be IR Commands in the table that no key points to, i.e. unpicked commands.

The second type of Blaster Command, called Send_IR_Command, is capable of causing the IR Blaster to send any possible IR Command for any of the IR formats in its library. An IR Blaster designed to accept only this type of Blaster Command does not need tables of IR Commands, because the IR Command and any required prefix data are explicitly provided every time. As shown in FIG. 6, which IR formatter to use is specified in field 185, any prefix data needed by the IR formatter is given in field 186, the IR Command code itself is given in field 187, and flags for exception processing appear in field 188.

An IR Blaster designed to accept Send_IR_For_Key commands is like a remote control with virtual keys—an external agent tells the IR Blaster which Device Type to emulate and which key is being pressed. In an Arbitrary IR Code Extender with this type of IR Blaster, the universal remote control is the external agent providing the Device Type, Key Code, and flags. If the IR Blaster is the Send_IR_Command type, the remote control must instead provide IR Formatter, IR Prefix Data, IR Command, and flag data. All of this information is available within the firmware running on the microcontroller 12 of a universal remote control 10 as shown in FIG. 1, but in the prior art this information is only used internally. According to the present invention, the information required for either type of Blaster Command is formatted into a packet and sent out by the remote control as an IR pulse train, or, as will be disclosed below, as an RF signal.

A packet suitable for sending a Blaster Command is shown in FIG. 7. Because the Blaster Command can be variable length, a Packet Length byte 190 is given, followed by a Command Type 191. The Command Type can indicate what type of Blaster Command follows, or it can take on other values to indicate other payloads in the packet. The Blaster Command bytes occupy field 192, followed by a checksum or CRC (cyclic redundancy check) so a receiver can validate packet integrity.

The Blaster Command Packet can be sent via IR, RF, or over a network. The information in the Blaster Command Packet can become the payload in a signaling protocol already defined for transport over these media, if available, or else a new signaling protocol can be defined for this purpose.

A signaling protocol suitable for IR transport would need to send a Blaster Command Packet in 100 milliseconds or less to avoid a delay perceptible by the user. With a one-byte Packet Length 190, Command Type 191 and Checksum 193, plus a Blaster Command 192 of 4 to 10 bytes, a Blaster Command Packet consists of 7 to 13 bytes, or 56 to 104 bits. Sending 104 bits in 100 milliseconds requires a bit rate of 1040 bits per second. With an IR pulse carrier of 38 KHz, a bit time is about 36 pulses. By Manchester encoding, each bit uses 18 pulses of carrier, with a one designated by 18 pulses in the first half of the bit time and a zero designated by 18 pulses in the second half of the bit time. Standard low-cost IR receiver modules can easily recover the Manchester encoded bitstream using such a protocol.

Learner Setup

One advantage of the Arbitrary IR Code Extender is that no setup is needed for sending IR Commands that are in the preprogrammed IR code libraries of both the universal remote control and the IR Blaster. However, some IR Blasters are capable of learning IR Commands from another remote control. In order for the IR Blaster to send a learned IR Command, the user must establish an association between a Blaster Command sent by the remote control and a learned IR Command in the IR Blaster.

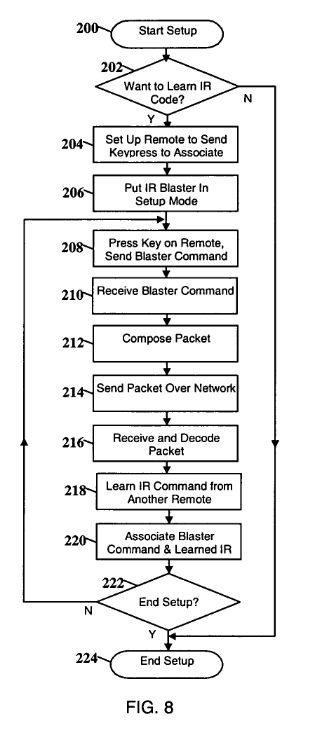

FIG. 8 is a flowchart showing how setup for an Arbitrary IR Code Extender is accomplished, beginning at step 200. At step 202, unless the user wants to set up a learned IR Command, no further action is required and the procedure terminates at step 224. To associate a keypress with a learned IR Command, the user first sets up the universal remote 10 of FIG. 1 to send the chosen keypress at step 204, then puts the Network-to-IR Unit 50 into setup mode at step 206, perhaps by pressing a setup button. At step 208, the user presses the chosen key, causing the remote to send the Blaster Command for that key. The IR-to-Network Unit 30 receives the Blaster Command via IR at step 210, reformats it into a packet suitable for transmission over the network at step 212, and sends it over the network using modem 38 at step 214. At step 216, the Network-to-IR Unit 50 receives the network packet, decodes the Blaster Command from it, and indicates to the user that it is ready to learn an IR Command, perhaps by blinking an LED or displaying a message on an LCD screen. The user teaches the IR Blaster inside the Network-to-IR Unit 50 an IR Command by pressing the desired button on an existing remote while pointing it at the IR detector 55 in step 218. The Network-to-IR Unit 50 updates an internal database with an association, preferably in nonvolatile memory, between the received Blaster Command and the learned IR Command at step 220. If the user wishes to set up another keypress/command association at step 222, the procedure resumes at step 208 when another key is pressed on the universal remote 10. Otherwise, the setup session is ended at step 224, for instance by pressing a setup button again on the IR-to-Network Unit 50.

Blaster Command Usage

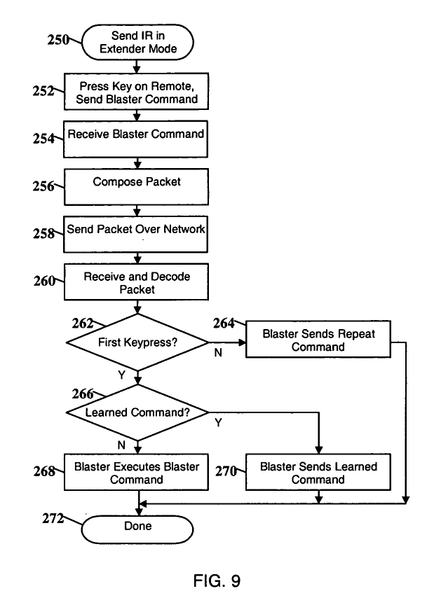

FIG. 9 is a flowchart showing a method for using the Arbitrary IR Code Extender. The procedure begins at step 250 when the remote control is in Extender Mode. At step 252 the user presses one of the keys on the universal remote control 10 of FIG. 1, causing it to send a Blaster Command. Following steps 254, 256, 258 and 260, the Blaster Command for the IR keypress is extracted from the IR pulse train, sent over the network, and received by the Network-to-IR Unit. These steps are the same as steps 210, 212, 214 and 216 of FIG. 8, respectively.

At step 262, the IR Blaster checks if the key is being held down or if it is being pressed for the first time. The Blaster Command flag field 182 of FIG. 5 or 188 of FIG. 6 can be used to indicate which condition is occurring. If it is a first keypress, then firmware checks at step 266 if there is an association in the database between the received Blaster Command and a learned IR Command. If there is, then at step 270 the IR Blaster sends the learned command. Otherwise the IR Blaster executes the Blaster Command by formatting the indicated IR Command as a pulse train and sending it using the IR emitter 54 of FIG. 1. The type of Blaster Command, Send_IR_For_Key or Send_IR_Command, can be determined using the Command Type field 191 of FIG. 7.

Back at step 262, if the remote control key is being held down, the IR Blaster formats whatever modification of the IR pulse train the IR protocol requires in order to indicate command repetition, and emits the modified pulse train at step 264. The procedure terminates at step 272.

RF Signaling

In FIG. 1, if the remote control 10 and the IR Blaster 50 are in the same space, there is a possibility that the Blaster Command sent by the remote will interfere with the IR Command sent by the IR Blaster, resulting in one or both signals being received improperly. A solution to this problem, shown in FIG. 2, is to add an RF transmitter 17 to the remote control 10 and an RF receiver 55 to the IR Blaster 50, then to send the Blaster Command via RF as shown by the symbol 18.

With the Blaster Command being sent by radio, the remote control 10 does not need to emit any IR signal in Extender Mode, so there is no possibility of interference with IR Commands being sent by an IR Extender in the same space. Alternatively, if there is no IR Blaster in the same space, there is no need for the remote control 10 to be placed in Extender Mode. Instead, the remote can send the normal IR Command via IR LED 14 and the Blaster Command via the RF transmitter 17.

RF signaling can be made more robust if the RF transmitter 17 and the RF receiver 55 are replaced with RF transceivers able to both send RF, shown as 18, and receive RF, shown as 19. In that case the RF protocol can require acknowledgement by the receiver that a message was received uncorrupted. Lacking acknowledgement, the sender can retry a certain number of times. If the user interface on the remote control comprises a display, the user can be informed whether the Blaster Command was sent successfully or not.

When the IR Blaster 50 is out of RF range of the remote control 10, the Blaster Command can be sent over a network as disclosed above. In that case, an RF-to-Network Unit 40 must be placed within RF range of the remote control, and the IR Blaster 50 must contain a network modem 58. The RF-to-Network Unit 40 comprises an RF receiver or transceiver 45, a microcontroller 42, and a network modem 48. Note that if an IR receiver 35 and IR emitter 34 are added to the RF-to-Network Unit 40, then it becomes identical to the Network-to-IR Unit 50, and the units can be manufactured and used interchangeably. Also note that the Network-to-IR Unit 50 FIG. 2 is equivalent to the Network-to-IR Unit 50 of FIG. 1 but with an RF subsystem 55 added. A preferred embodiment is thus for units with network modems to accept an RF transceiver as a daughter board.

When multiple devices in a mesh network configuration communicate with one another, and especially if the devices communicate using two different physical media, such as RF and powerline, they must use a networking protocol that avoids signals jamming each other. Such a protocol, known as Insteon™, is disclosed in U.S. patent application Ser. No. 11/012,616, filed Dec. 15, 2004, entitled Mesh Network of Intelligent Devices Communicating via Powerline and Radio Frequency. In the Insteon protocol, all devices are transceivers and repeaters, with the property that adding more devices to a network makes communications more robust and reliable.

Controlling Non-IR Devices with User-Associated IR Codes

A non-IR controllable but networked unit such as Network Unit 60 shown in FIG. 1 can be controlled with an IR remote control 10 via an IR-to-Network Unit 30. The method is similar to that employed by the User-Associated IR Code Extender above, but in this case the IR-to-Network Unit 30 contains associations between received IR Commands and Network Commands. When the IR-to-Network Unit receives an IR Command, it checks its database for an associated Network Command, and if there is one the IR-to-Network Unit sends it over the network 70 for Network Unit 60 to execute.

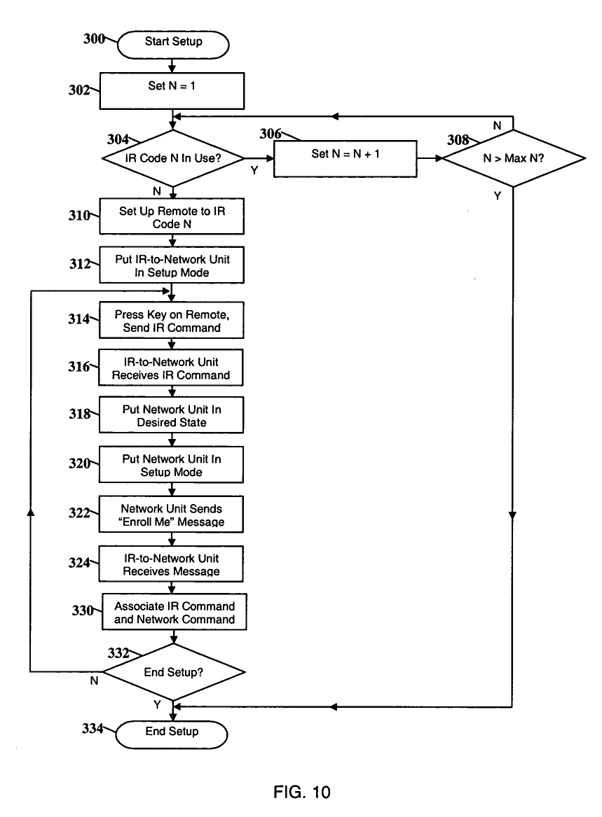

FIG. 10 is a flowchart showing a method for associating an IR Command with a Network Command for controlling a Network Unit. Beginning at step 300, the user sets up a universal remote 10 of FIG. 1 to send IR Commands that are not already being employed to control equipment the user owns. The steps 302 through 310 of FIG. 10 are the same as steps 102 through 110 of FIG. 3 respectively, as disclosed above.

Once an unused set of IR Commands has been identified, the user places the IR-to-Network Unit 30 of FIG. 1 into setup mode, perhaps by pressing a setup button on the unit. At step 314, the user chooses and presses a key on the remote control to associate with a Network Command, causing the remote to send an IR Command. The IR-to-Network Unit receives the IR Command at step 316 and waits for a Network Unit to communicate via the network. At step 318 the user places the Network Unit that is to be controlled, 60 of FIG. 1, into the state it should be in when it receives the Network Command, then at step 320 the user places the Network Unit 60 into setup mode, perhaps by pressing a button on the unit. In setup mode at step 322, the Network Unit 60 sends a message over the network to the IR-to-Network Unit 30 telling the IR-to-Network Unit what Network Command to send in order for the Network Unit to go into the state it was put into at step 318. In step 322, this message is called the Enroll Me message. When the IR-to-Network Unit 30 receives the Enroll Me message at step 324, it creates an association in a database between the IR Command received at step 316 and the Network Command determined from the Enroll Me message.

If at step 332 the user wishes to associate another IR Command with a Network Command, the procedure is repeated beginning at step 314; otherwise the setup procedure terminates at step 334.

It should be understood that there are alternate methods for the Network Unit 60 and the IR-to-Network Unit 30 to communicate in order for the Network Unit to be controlled by the IR-to-Network Unit. For example, a user interface on the IR-to-Network Unit, on the Network Unit, or on another device connected to the network could prompt the user to establish what Network Commands to execute.

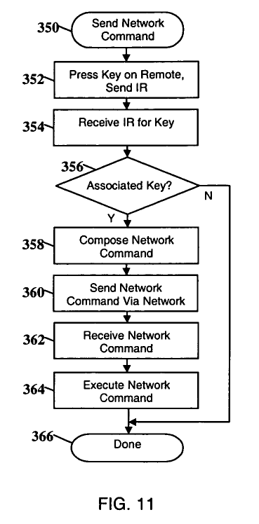

Once setup is completed, Network Units can be controlled with associated IR Commands as shown in the flowchart of FIG. 11, beginning at step 350. At step 352 when the user presses a key on the remote control 10 of FIG. 1, the remote sends the IR Command for that key. At step 354 the IR-to-Network Unit 30 of FIG. 1 receives the IR Command and at step 356 it checks its database for an associated Network Command. If there is no association, the process terminates at step 366, but if there is, the IR-to-Network Unit composes the associated Network Command into a network message at step 358 and sends it over the network at step 360. At step 362 the associated Network Unit 60 of FIG. 1 receives the Network Command and executes it at step 364. The procedure terminates at step 366. Depending on the network protocol, the Network Unit 60 may acknowledge receipt and execution of the Network Command, and if such acknowledgement is not received, the IR-to-Network Unit 30 may retry sending the Network Command.

Controlling Non-IR Devices Directly with Network Commands

It is possible for the remote control 10 of FIG. 1 to send Network Commands directly to a Network Unit 60 using the IR-to-Network Unit 30 merely as a bridging device. That is, the remote control composes Network Commands on its own as network messages, sends them to the IR-to-Network Unit using an IR protocol such as that disclosed above for Blaster Commands, and the IR-to-Network Unit simply places the network messages on the network without altering them.

There are two difficulties with this method. One is that robust communication protocols require two-way signaling, and most IR remote controls are one-way—they send IR but do not receive it. While it is possible to implement two-way IR communications using an IR detector in the remote control and an IR emitter in the IR-to-Network Unit, two-way IR communications is not particularly reliable because the user must continuously point the remote in a line-of-sight during both transmission and reception. The second difficulty is that now the remote control rather than the IR-to-Network Unit must establish an association database between keypresses and Network Commands to send to Network Units to be controlled. Without two-way communications, the user interface would be very complex, and the remote control would have to contain an extensive database of available Network Units to control, including proper Network Commands and addresses of units.

A better solution and a preferred embodiment, as shown in FIG. 2, is to include an RF transceiver 17 in the remote control 10. In that case, if the Network Unit 60 receiving Network Commands from the remote control contains an RF transceiver 65, and the Network Unit is within RF range of the remote control, then the two devices can communicate directly. In other words, RF becomes the networking medium. If the remote control and the Network Unit are not within range of each other, then an RF-to-Network unit 40 containing an RF transceiver 45 can relay messages over another network 70, such as the powerline.

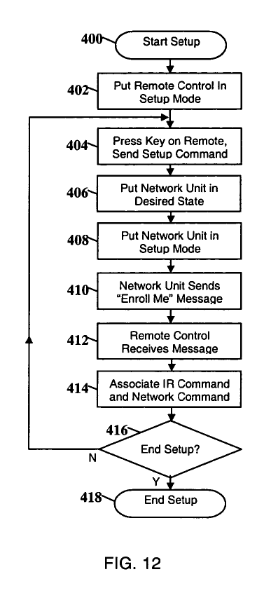

Because communication is two-way between the remote control and Network Units, a setup method such as that shown in FIG. 12 can be used to establish associations between keypresses and Network Commands. The procedure begins at step 400. At step 402, the user places the remote control 10 of FIG. 2 into setup mode by means of an appropriate user interface. At step 404, the user chooses and presses a key on the remote control to associate with a Network Command. The remote sends an RF message notifying Network Units 60 that are within range that the remote is in setup mode, and then waits for a Network Unit to respond. As disclosed above, intermediate units 30 may relay this RF message over another network to reach a larger number of Network Units. At step 406 the user places the Network Unit 60 that is to be controlled by the keypress into the state it should be in when it receives the Network Command. Then at step 408 the user places the Network Unit 60 into setup mode, perhaps by pressing a button on the unit. In setup mode at step 410, the Network Unit 60 sends a message via RF or over the network to the remote control 10 telling the remote control what Network Command to send in order for the Network Unit to go into the state it was put into at step 406. In step 410, this message is called the Enroll Me message. When the remote control 10 receives the Enroll Me message at step 412, it creates an association in a database between the keypress at step 304 and the Network Command determined from the Enroll Me message.

If at step 416 the user wishes to associate another keypress with a Network Command, the procedure is repeated beginning at step 404; otherwise the setup procedure terminates at step 418.

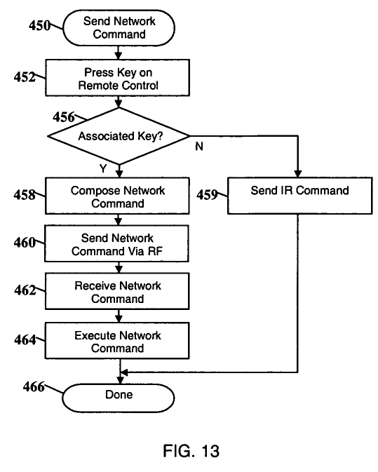

Once setup is completed, keypresses on the remote control 10 of FIG. 2 can control associated Network Units as shown in the flowchart of FIG. 13, beginning at step 450. At step 452, when the user presses a key on the remote control, the remote checks its database at step 456 for an associated Network Command. If there is no association, the remote sends the normal IR Command for that key at step 459 and the process terminates at step 466. If there is an associated Network Command in the database, the remote control composes the Network Command into a network message at step 458 and sends it via RF at step 460. Again, intermediate units may relay this RF message over another network to reach the Network Unit being controlled. At step 462 the associated Network Unit 60 of FIG. 2 receives the Network Command and executes it at step 464. The procedure terminates at step 466. Depending on the network protocol, the Network Unit 60 may acknowledge receipt and execution of the Network Command, and if such acknowledgement is not received, the remote control 10 may retry sending the Network Command.

From the foregoing description it will be apparent that the system and method for remote operation of local or distant infrared-controllable and non-infrared-controllable devices have a number of advantages, some of which have been described above and others of which are inherent in the present invention.

Also, it will be understood that modifications can be made to the system and methods of the present invention without departing from the teachings of the present invention. Accordingly, the scope of the present invention is only to be limited as necessitated by the accompanying claims.

What is claimed is:

1. A system for operating infrared-controllable apparatus, said system comprising
a remote control comprising circuitry for sending infrared signals;
first apparatus comprising circuitry for receiving first infrared signals from said remote control, circuitry for decoding data from said first infrared signals, and circuitry for sending said data over a communications network; and
second apparatus comprising circuitry for receiving said data over said communications network and circuitry for sending second infrared signals associated with said received data to said infrared-controllable apparatus.

2. A system as recited in claim 1 wherein said communications network comprises radio-frequency signaling circuitry.

3. A system as recited in claim 1 wherein said communications network comprises powerline signaling circuitry.

4. A system as recited in claim 1 wherein said communications network comprises Internet signaling circuitry.

5. A system as recited in claim 1 wherein said remote control is a universal remote control comprising a preprogrammed library containing a plurality of infrared commands for operating a plurality of infrared-controlled apparatus.

6. A system as recited in claim 5 wherein said first infrared signals from said remote control operate infrared-controlled apparatus not present within range of said remote control.

7. A system as recited in claim 1 wherein said circuitry for sending said second infrared signals comprises a preprogrammed library containing a plurality of infrared commands for operating a plurality of infrared-controlled apparatus.

8. A system as recited in claim 1 wherein said circuitry for sending said second infrared signals comprises circuitry for learning from a remote control a plurality of infrared commands for operating a plurality of infrared-controlled apparatus.

9. A system as recited in claim 1 wherein said second apparatus comprises circuitry for associating said received data from said first infrared signals with said second infrared signals for operating infrared-controlled apparatus.

10. A system for operating infrared-controllable apparatus, said system comprising
a remote control comprising circuitry for wirelessly sending commands to an infrared blaster comprising infrared-emitting circuitry able to operate infrared-controllable apparatus; and
apparatus comprising said infrared blaster, circuitry for receiving said commands for controlling said infrared blaster from said remote control, and circuitry for applying said received commands to said infrared blaster.

11. A system as recited in claim 10 wherein said circuitry for wirelessly sending commands to said infrared blaster comprises infrared signaling circuitry.

12. A system as recited in claim 10 wherein said circuitry for wirelessly sending commands to said infrared blaster comprises radio-frequency signaling circuitry.

13. A system as recited in claim 10 wherein said circuitry for receiving commands for controlling said infrared blaster comprises infrared signal receiving circuitry.

14. A system as recited in claim 10 wherein said circuitry for receiving commands for controlling said infrared blaster comprises radio-frequency receiving circuitry.

15. A system as recited in claim 10 wherein said commands for controlling said infrared blaster sent wirelessly by said remote control are relayed over a communications network by apparatus comprising circuitry for wirelessly receiving said commands from said remote control and circuitry for relaying said commands over said communications network, and wherein said circuitry for receiving said commands and applying them to control said infrared blaster comprises circuitry for communicating over said communications network.

16. A system as recited in claim 15 wherein said communications network comprises radio-frequency signaling circuitry.

17. A system as recited in claim 15 wherein said communications network comprises powerline signaling circuitry.

18. A system as recited in claim 15 wherein said communications network comprises Internet signaling circuitry.

19. A system as recited in claim 10 wherein said infrared blaster comprises a preprogrammed library containing a plurality of infrared commands for operating a plurality of infrared-controlled apparatus.

20. A system as recited in claim 10 wherein said infrared blaster comprises circuitry for learning from a remote control a plurality of infrared commands for operating a plurality of infrared-controlled apparatus.

21. A system for operating non-infrared-controllable apparatus, said system comprising
a remote control comprising circuitry for wirelessly sending signals;
first apparatus comprising circuitry for receiving wireless signals from said remote control and circuitry for sending over a communications network associated commands for operating a second apparatus connected to said communications network; and
one or more of said second apparatus comprising circuitry for receiving said commands over said communications network and executing said commands.

22. A system as recited in claim 21 wherein said circuitry for wirelessly sending signals to said first apparatus comprises infrared signaling circuitry.

23. A system as recited in claim 21 wherein said circuitry for wirelessly sending signals to said first apparatus comprises radio-frequency signaling circuitry.

24. A system as recited in claim 21 wherein said circuitry for receiving wireless signals comprises infrared signal receiving circuitry.

25. A system as recited in claim 21 wherein said circuitry for receiving wireless signals comprises radio-frequency receiving circuitry.

26. A system as recited in claim 21 wherein said communications network comprises radio-frequency signaling circuitry.

27. A system as recited in claim 21 wherein said communications network comprises powerline signaling circuitry.

28. A system as recited in claim 21 wherein said communications network comprises Internet signaling circuitry.

29. A system as recited in claim 22 wherein said remote control is a universal remote control comprising a preprogrammed library containing a plurality of infrared commands for operating a plurality of infrared-controlled apparatus.

30. A system as recited in claim 29 wherein said infrared signals from said remote control operate infrared-controlled apparatus not present within range of said remote control.

31. A system for operating non-infrared-controllable apparatus, said system comprising
a remote control comprising circuitry for wirelessly exchanging messages with non-infrared-controllable apparatus, circuitry for associating keypresses on said remote control with commands for operating said non-infrared-controllable apparatus; and
one or more of said non-infrared-controllable apparatus comprising circuitry for exchanging messages with said remote control, circuitry for executing commands received from said remote control, and circuitry for communicating with said remote control to establish in said remote control an association between keypresses on said remote control and commands for operating said non-infrared-controllable apparatus.

32. A system as recited in claim 31 wherein said circuitry for wirelessly exchanging messages between said remote control and said non-infrared-controllable apparatus comprises radio-frequency signaling circuitry.

33. A system as recited in claim 31 wherein said messages wirelessly exchanged between said remote control and said non-infrared-controllable apparatus are relayed over a communications network by apparatus comprising circuitry for wirelessly communicating with said remote control and circuitry for relaying said commands over said communications network, and wherein said non-infrared-controllable apparatus comprises circuitry for communicating over said communications network.

34. A system as recited in claim 33 wherein said communications network comprises radio-frequency signaling circuitry.

35. A system as recited in claim 33 wherein said communications network comprises powerline signaling circuitry.

36. A system as recited in claim 33 wherein said communications network comprises Internet signaling circuitry.

37. A method for operating infrared-controllable apparatus, said method comprising the steps of
sending a first infrared signal from an infrared-emitting remote control;
receiving said first infrared signal from said remote control, decoding data from said first infrared signal, and sending said data over a communications network; and
receiving said data over said communications network and sending a second infrared signal associated with said received data to said infrared-controllable apparatus.

38. A method as recited in claim 37 wherein the steps of sending and receiving data over said communications network comprise sending and receiving data using radio-frequency signaling.

39. A method as recited in claim 37 wherein the steps of sending and receiving data over said communications network comprise sending and receiving data using powerline signaling.

40. A method as recited in claim 37 wherein the steps of sending and receiving data over said communications network comprise sending and receiving data using Internet signaling.

41. A method as recited in claim 37 wherein the step of sending said first infrared signal from said infrared-emitting remote control comprises composing said first infrared signal from a preprogrammed library containing a plurality of infrared commands for operating a plurality of infrared-controlled apparatus.

42. A method as recited in claim 41 wherein the step of sending said first infrared signal from said infrared-emitting remote control comprises sending a signal for operating infrared-controlled apparatus not present within range of said remote control.

43. A method as recited in claim 37 wherein the step of sending said second infrared signal comprises composing said second infrared signal from a preprogrammed library containing a plurality of infrared commands for operating a plurality of infrared-controlled apparatus.

44. A method as recited in claim 37 wherein the step of sending said second infrared signal comprises sending said second infrared signal learned from a remote control.

45. A method as recited in claim 37 further comprising the step of associating said received data from said first infrared signals with said second infrared signal for operating infrared-controlled apparatus.

46. A method for operating infrared-controllable apparatus, said method comprising the steps of
wirelessly sending commands from a remote control to an infrared blaster comprising infrared-emitting circuitry able to operate infrared-controllable apparatus; and
receiving said commands for controlling said infrared blaster from said remote control, and applying said received commands to said infrared blaster.

47. A method as recited in claim 46 wherein said step of wirelessly sending commands from said remote control comprises sending commands using infrared signaling.

48. A method as recited in claim 46 wherein said step of wirelessly sending commands from said remote comprises sending commands using radio-frequency signaling.

49. A method as recited in claim 46 wherein said step of receiving commands from said remote control comprises receiving commands using infrared signaling.

50. A method as recited in claim 46 wherein said step of receiving commands from said remote control comprises receiving commands using radio-frequency signaling.

51. A method as recited in claim 46 wherein step of sending commands from a remote control to an infrared blaster further comprises relaying said commands over a communications network by apparatus comprising circuitry for wirelessly receiving said commands from said remote control and circuitry for relaying said commands over said communications network, and wherein the step of receiving said commands and applying them to control said infrared blaster further comprises receiving said commands over said communications network.

52. A method as recited in claim 51 wherein the steps of sending and receiving commands over said communications network comprise sending and receiving commands using radio-frequency signaling.

53. A method as recited in claim 51 wherein the steps of sending and receiving commands over said communications network comprise sending and receiving commands using powerline signaling.

54. A method as recited in claim 51 wherein the steps of sending and receiving commands over said communications network comprise sending and receiving commands using Internet signaling.

55. A method as recited in claim 46 wherein the step of applying said received commands to said infrared blaster further comprises said infrared blaster sending infrared signals composed from a preprogrammed library containing a plurality of infrared commands for operating a plurality of infrared-controlled apparatus.

56. A method as recited in claim 46 wherein the step of applying said received commands to said infrared blaster further comprises said infrared blaster sending infrared commands learned from a remote control.

57. A method for operating non-infrared-controllable apparatus, said method comprising the steps of
wirelessly sending signals from a remote control;
receiving wireless signals from said remote control by a first apparatus and sending over a communications network associated commands for operating a second apparatus connected to said communications network;
receiving said commands by said second apparatus over said communications network and executing said commands.

58. A method as recited in claim 57 wherein said step of wirelessly sending signals from said remote control comprises sending signals using infrared signaling.

59. A method as recited in claim 57 wherein said step of wirelessly sending signals from said remote control comprises sending signals using radio-frequency signaling.

60. A method as recited in claim 57 wherein said step of receiving signals from said remote control comprises receiving signals using infrared signaling.

61. A method as recited in claim 57 wherein said step of receiving signals from said remote control comprises receiving signals using radio-frequency signaling.

62. A method as recited in claim 57 wherein the steps of sending and receiving commands over said communications network comprise sending and receiving commands using radio-frequency signaling.

63. A method as recited in claim 57 wherein the steps of sending and receiving commands over said communications network comprise sending and receiving commands using powerline signaling.

64. A method as recited in claim 57 wherein the steps of sending and receiving commands over said communications network comprise sending and receiving commands using Internet signaling.

65. A method as recited in claim 58 wherein the step of sending said infrared signal from said infrared-emitting remote control comprises composing said infrared signal from a preprogrammed library containing a plurality of infrared commands for operating a plurality of infrared-controlled apparatus.

66. A method as recited in claim 58 wherein the step of sending said infrared signal from said infrared-emitting remote control comprises sending a signal for operating infrared-controlled apparatus not present within range of said remote control.

67. A method for operating non-infrared-controllable apparatus, said method comprising the steps of
wirelessly communicating with a remote control to establish in said remote control an association between keypresses on said remote control and commands for operating said non-infrared-controllable apparatus;
exchanging messages between said remote control and said non-infrared-controllable apparatus; and
executing commands received from said remote control by said non-infrared-controllable apparatus.

68. A method as recited in claim 67 wherein said step of wirelessly communicating with said remote control comprises communicating using radio-frequency signaling.

69. A method as recited in claim 67 wherein the step of exchanging messages between said remote control and said non-infrared-controllable apparatus further comprises relaying said messages over a communications network by apparatus comprising circuitry for wirelessly exchanging messages with said remote control and circuitry for relaying said messages over said communications network.

70. A method as recited in claim 69 wherein the steps of exchanging messages over said communications network comprises exchanging messages using radio-frequency signaling.

71. A method as recited in claim 69 wherein the steps of exchanging messages over said communications network comprises exchanging messages using powerline signaling.

72. A method as recited in claim 69 wherein the steps of exchanging messages over said communications network comprises exchanging messages using Internet signaling.
